(19) United States
(12) Patent Application Publication
(10) Pub. No.: US 2005/0206159 A1
(43) Pub. Date: Sep. 22, 2005

(54) Embossed marking

(75) Inventors: Teresa Ancona, Nyon (CH); Tony Manganelli, Lausanne (CH)

Correspondence Address: CONNOLLY BOVE LODGE & HUTZ, LLP, P O BOX 2207, WILMINGTON, DE, 19899, US

(73) Assignee: Philip Morris Products, S.A., Neuchatel (CH)

(21) Appl. No.: 10/518,729

(22) PCT Filed: Jun. 19, 2003
(86) PCT No.: PCT/CH03/00397

§ 371 Date: Dec. 20, 2004

(30) Foreign Application Priority Data
Jun. 21, 2002 (EP) 02405517.0

(51) Int. Cl. B42D 15/00

(52) U.S. Cl. 283/94

(57) ABSTRACT

1. <sic.> Material (1) made up of at least a first (2) and a second (3) sheet each having two opposite faces (21, 22, 31, 32) designated as front (21, 31) and back (22, 32) faces, at least one (21, 31) of these faces being intended to bear legible printed information (4), constituting a text (4) for example,
this material being characterised in that, in addition to the printed information (4), at least one of said front faces (21, 31) bears legible information (5) which, distinct from the printed information (4), is made up in the form of reliefs (51) which appear to be superimposed on the legible printed information (4).

The invention relates to a material made up of at least one sheet having two faces of which at least the one is intended to bear legible printed information, constituting a text for example.

The material of the invention can be used to make up at least part of a packaging, including a receptacle such as a box or small case.

For example, the material can be used to make up the receptacle itself and/or an inner lining of this receptacle, or even an outer wrapping.

The invention thus concerns more specifically, but not exclusively, the field of packaging.

The invention concerns any application in which a packaging of reduced dimensions must bear numerous printed pieces of information, i.e. information constituting, for example, a text or an image that a seeing person can read and/or notice.

The invention applies preferably, but not in a limiting way, to the packaging of products of the tobacco industry.

One result which the invention aims to obtain is a material which, made up of at least one sheet, permits bearing a number of pieces of information legible to a person which is increased with respect to the number of pieces of legible information that a conventional material permits bearing.

To this end, the invention has as its subject matter a material characterised in particular in that in addition to the printed data, the printed face bears legible data which, distinct from said printed information, are made up in the form of reliefs which appear as to be superimposed on the legible printed information 4<sic.>.

The invention also has as subject matter:
a packaging including a receptacle which is made up at least in part of the aforementioned material,
an inner lining for the receptacle which is made up at least in part of the aforementioned material,
an outer wrapping for the receptacle which is made up at least in part of the aforementioned material.

The invention will be better understood from reading the description given in the following, by way of non-limiting example, with reference to the attached drawing representing schematically:

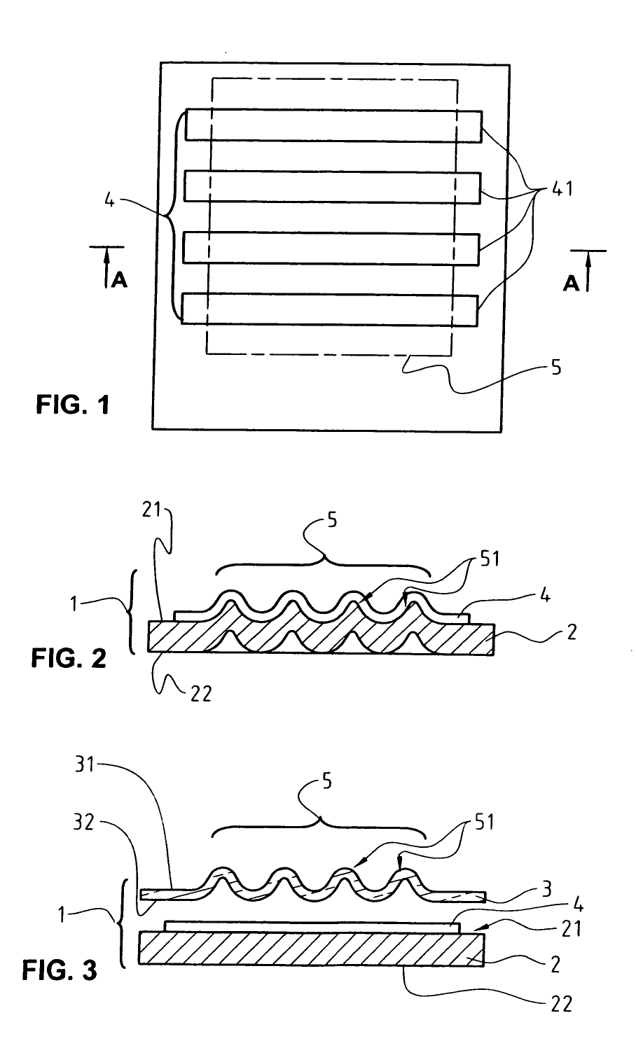

FIG. 1: a view of one of the faces of a material according to the invention,

FIG. 2: a view in section of the material of FIG. 1, according to a first embodiment,

FIG. 3: a view in section of the material of FIG. 1, according to a second embodiment,

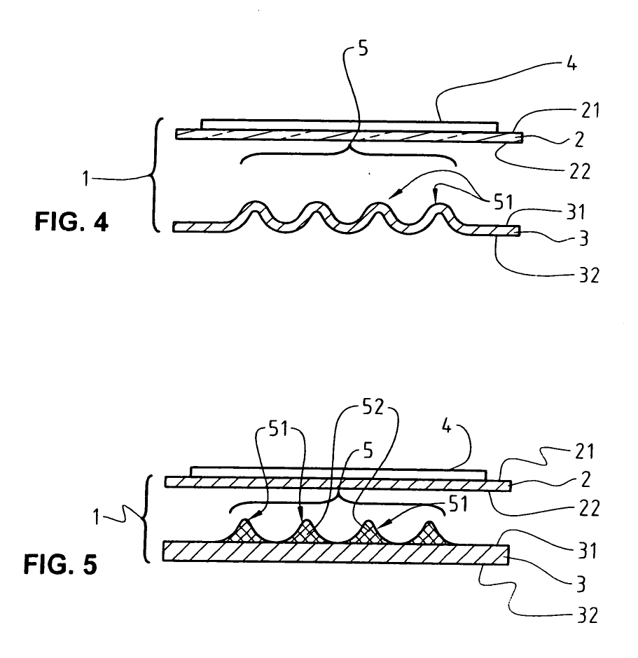

FIG. 4: a view in section of the material of FIG. 1, according to a third embodiment,

FIG. 5: a view in section of the material of FIG. 1, according to a fourth embodiment,

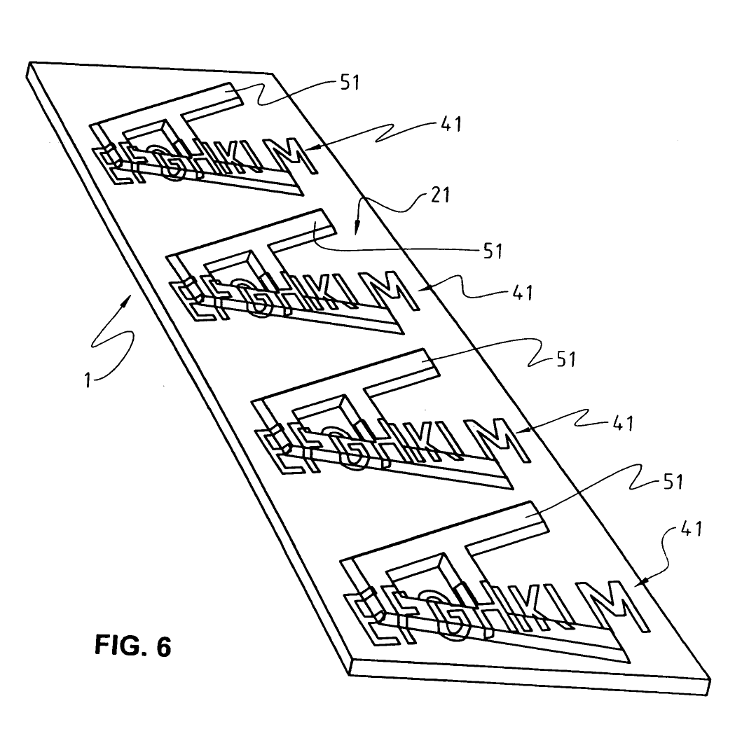

FIG. 6: a view in perspective of a face of a material according to the invention.

Referring to the drawing, one sees a material 1 made up of at least a first 2 and a second 3 sheet, each having two opposite faces 21, 22, 31, 32, designated as front faces 21, 31 and back faces 22, 32, at least one 21, 31 of these faces being intended to bear legible printed information 4, constituting a text 4 for example.

As has already been stated, designated by printed information 4 is information constituting a text or an image which a seeing person can notice.

Printed information is formed, for example, through ink deposit, but this is not limiting. The data designated as printed could also consist of a photograph, a drawing, a combination of texts, of images.

In the attached drawing, in FIG. 1, shown is a view of the material allowing in particular the printed face 21 to be observed.

As has been symbolised, the printed data 4 are, for example, lines 41 of characters constituting a legible text 4.

In a noteworthy way (FIGS. 1 and 2), in addition to printed data 4, at least one of said front faces 21, 31 bears legible information 5 which, distinct from said printed data 4, is composed in the form of reliefs 51, designated in the following as information in relief 5, which appears to be superimposed on the legible printed information 4.

As has been symbolised, the information in relief 5 is composed, for example, by a group 5 of lines of characters 51 in relief constituting a legible text 5.

FIGS. 2 to 5 are cross sections of FIG. 1 along the plane AA.

For example, the information in relief 5 is made up by local deformation, along the thickness of at least one of the first and second sheets 2, 3.

This technique of local deformation is known by the name of embossing.

According to another embodiment (FIG. 5), the information in relief 5 is formed through deposit of an element in relief 52 on at least one of said front faces 21, 31 of at least one of said first and second sheets 2, 3.

The element in relief 52 can be of any known type, and may consist, for instance, of a deposit of ink or a deposit of thermo-fusible substance.

The thickness of the deformation or of the deposit of material must be sufficient to constitute a legible relief.

One skilled in the art is able to determine the nature of the substance making up each element in relief as well as its thickness, without having to give evidence of invention.

According to another embodiment, the information in relief 5 is formed by local modification of the state of the surface of at least one of said front faces 21, 31 of at least one of said first and second sheets 2, 3.

The local modification of the surface results from local polishing, or from the contrary, a local unpolishing.

The term relief thus has a very broad meaning. Essential is that the manner in which the information in relief is formed does not change the legibility of said printed information.

One skilled in the art is able to determine the technique best adapted to obtain this local polishing or this local unpolishing.

In a noteworthy way (FIG. 2), the material 1 includes a single sheet 2 made up of one 2 of said first and second sheets 2, 3, and the printed information 4 as well as the information in relief are borne by this sheet 2.

In another way (FIG. 3) which is noteworthy, the material 1 includes at least two sheets 2, 3 constituted by said first and second sheets 2, 3, of which:
said first sheet 2 is made up of opaque material and whose said front face 21 bears the printed information 4,
said second sheet 3 is made up of transparent material, and
   on the one hand, at least whose said front face 31 bears the information in relief, and
   on the other hand, is superimposed on the front face 21 of the first sheet 2 which bears the printed information 4.

The printed information 4 are thus observable through the sheet 3 which, made up of transparent material, itself bears the information in relief 5.

The two sheets 2, 3 can be fitted together or simply superimposed.

In the drawings, in particular the thicknesses of the sheets 2, 3 have been appreciably increased so as to facilitate reading, but this does not have a limiting character.

In a different way (FIG. 4), but likewise noteworthy, the material 1 is includes at least two sheets 2, 3 constituted by said first and second sheets 2, 3, of which:
said second sheet 3 is made up of opaque material and whose said front face 31 bears the information in relief 5,
said first sheet 2 is made up of transparent and flexible material, <and >
   bears the printed information 4 at least on its front face 21, and
   is superimposed on the front face 31 of said second sheet 3 which bears the information in relief 5.

The two sheets 2, 3 can also be fitted together or simply superimposed.

According to a variant (FIG. 5), likewise noteworthy, the material 1 includes at least two sheets 2, 3 constituted by said first and second sheets 2, 3, of which:
said second sheet 3 is made up of opaque material and whose said front face 31 bears the information in relief 5,
said first sheet 2 is made up of opaque and flexible material, and
   bears the printed information 4 at least on its front face 21, and
   is closely superimposed on the front face 31 of said second sheet 3 which bears the information in relief 5.

In this case, the sheets are closely applied one on the other in a manner such that the information in relief actually appears through the sheet 2 made up of opaque and flexible material.

Although this does not appear in an obvious way when examining the drawings, the invention also has as subject matter a packaging, including a receptacle such as a box or small case, and at least one part of which is made up of the aforementioned material.

For example, the material is used to make up:
a receptacle wall,
an inner lining of this receptacle,
a product of outer wrapping,
a receptacle wall provided with an outer wrapping.

1. Material (1) made up of at least a first (2) and a second (3) sheet each having two opposite faces (21, 22, 31, 32) designated as front (21, 31) and back (22, 32) faces, at least one (21, 31) of these faces being intended to bear legible printed information (4), constituting a text (4) for example,
this material being characterised in that, in addition to the printed information (4), at least one of said front faces (21, 31) bears legible information (5) which, distinct from the printed information (4), is made up in the form of reliefs (51) which appear to be superimposed on the legible printed information (4).

2. Material according to claim 1, characterised in that the information in relief (5) is formed by local deformation along the thickness of at least one of the first and second sheets (2, 3).

3. Material according to claim 1, characterised in that the information in relief (5) is formed by deposit of an element in relief (52) on at least one of said front faces (21, 31) of at least one of said first and second sheets (2, 3).

4. Material according to claim 1, characterised in that the information in relief (5) is composed by local modifcation of the state of the surface of at least one of said front faces (21, 31) of at least one of said first and second sheets (2, 3).

5. Material according to claim 4, characterised in that the material (1) includes a single sheet (2) constituted by one (2) of said first and second sheets (2, 3), and the printed information (4) as well as the information in relief (5) are borne by this sheet (2).

6. Material according to claim 4, characterised in that it includes at least two sheets (2, 3) constituted by said first and second sheets (2, 3), of which:
said first sheet (2) is made up of opaque material and whose said front face (21) bears the printed information (4),
said second sheet (3) is made up of transparent material, and
on the one hand, at least whose said front face (31) bears the information in relief (5), and
on the other hand, is superimposed on the front face (21) of the first sheet (2) that bears the printed information (4).

7. Material according to claim 4, characterised in that it includes at least two sheets (2, 3) constituted by said first and second sheets (2, 3), of which:
said second sheet (3) is made up of opaque material and whose said front face (31) bears the information in relief (5),
said first sheet (2) is made up of transparent and flexible material <and >
bears the printed information (4) at least on its front face (21), and
is superimposed on the front face (31) of said second sheet (3) which bears the information in relief (5).

8. Material according to claim 4, characterised in that it comprises at least two sheets (2, 3) constituted by said first and second sheets (2, 3), of which:
said second sheet (3) is made up of opaque material and whose said front face (31) bears the information in relief (5),
said first sheet (2) is made up of opaque and flexible material, and
bears the printed information (4) at least on its front face (21), and
is closely superimposed on the front face (31) of said second sheet (3) which bears the information in relief (5).

9. Packaging comprising a receptacle, characterised in that this receptacle is made up at least in part of a material accoridng to claim 8.

10. Inner lining for a receptacle, characterised in that it is made up at least in part of a mateiral accoridng to claim 8.

11. Outer wrapping for a receptacle characterised in that this outer wrapping is made up at least in part of a material according to claim 8.
